(19) United States
(12) Patent Application Publication
(10) Pub. No.: US 2012/0267356 A1
(43) Pub. Date: Oct. 25, 2012

(54) GROUNDING STRUCTURE, AND HEATER AND CHEMICAL VAPOR DEPOSITION APPARATUS HAVING THE SAME

(75) Inventors: Jeong-Duck Choi, Seoul (KR); Hyun-Mi Yuk, Gyeonggi-do (KR); Jin-Sik Choi, Seoul (KR)

(73) Assignee: KOMICO, LTD., Gyeonggi-do (KR)

(21) Appl. No.: 13/517,149

(22) PCT Filed: Nov. 24, 2010
(86) PCT No.: PCT/KR10/08348

§ 371 Date: Jun. 19, 2012

(30) Foreign Application Priority Data
Dec. 21, 2009 (KR) 10-2009-0127637

(51) Int. Cl. H05B 3/00; H01R 4/66

(52) U.S. Cl. 219/209; 174/6

(57) ABSTRACT

A ground structure for a PECVD apparatus includes a ground connector is positioned in a receiving portion of a ground mount that is connected to an electrical reservoir. A cylindrical ground clamp holds the ground connector and includes an opening portion along a sidewall in a longitudinal direction. An outer surface of the ground connector makes contact with an inner surface of the ground clamp. A pair of stumbling portions are folded from an outer surface of the ground clamp and spaced apart from each other by a width of the opening portion. A ground wiring is connected to the ground clamp and the ground mount, and the ground current flows to the ground mount via the ground clamp by the ground wiring, thus the ground current is grounded to the electrical reservoir. Accordingly, the electric arc is prevented between the ground connector and the ground clamp.

### TECHNICAL FIELD

Example embodiments relate to a ground structure, and a heater and a chemical vapor deposition apparatus including the same, and more particularly, to a ground structure in a heater for heating a substrate and a heater and a chemical vapor deposition apparatus in which the ground structure is arranged.

### BACKGROUND ART

Various chemical vapor deposition (CVD) processes have been used in a field of semiconductor devices and flat panel display (FPD) devices for forming various thin layers on a substrate such as a wafer and a glass panel by chemical reactions of source gases.

Particularly, as the integration degree has been increased and the critical dimension (CD) or the line width has been reduced in recent integrated circuit devices and FPE devices according to recent market trends of light, thin, short and small electronic products, a plasma-enhanced CVD (PECVD) process has been widely used for forming the thin layer on the substrate due to excellent gap-fill characteristics thereof.

A conventional PECVD apparatus usually includes a process chamber having an isolated inner space in which the thin layer is formed on a substrate, a shower head positioned at an upper portion of the process chamber and injecting source gases for a deposition process, a plasma electrode to which an electrical power is applied so as to transform the sources gases into plasma, a heater positioned at a lower portion of the process chamber correspondently to the shower head and heating the substrate, which is usually supported by the heater, a power line for applying an electrical power to the heater and a ground structure for plasma uniformity.

A ground electrode and a heating unit are installed in a body of the heater. The power line is connected to the heating unit of the heater and the ground structure is connected to the ground electrode of the heater. The ground structure is usually positioned at a lower portion of the heater and guides a portion of the electrical power applied to the plasma electrode to the inner space of the process chamber. Thus, the plasma of the source gases becomes uniform in the process chamber.

The conventional ground structure usually includes a ground connector extending from the ground electrode positioned at an upper portion of the heater, an elastic holder for holding the ground connector and a ground mount onto which the holder is mounted. Wirings electrically connected to the ground connector are usually connected to heater or a sidewall of the process chamber via the ground mount, thereby forming a ground circuit. The elastic holder includes an elastic body making contact with the ground connector and at least a bolt screwed into the elastic body, and thus the ground connector is secured to the ground mount by a screw joint.

According to a general theory of the screw joint, the ground connector is secured to the elastic holder by an initial joint force caused by a tensional force of the bolt and thus there is a problem in that the initial joint force cannot be stable due to thermal expansion of the ground connector.

Since the ground connector is positioned under the heater in the process chamber in which a plasma process is performed, the ground connector usually requires sufficient thermal conductivity and electrical conductivity so as to form the ground circuit in a high temperature condition of the process chamber. However, the sufficient thermal conductivity and electrical conductivity of a material generally cause large thermal variation of the material, and thus the conventional ground connector usually undergoes thermal expansion in performing the plasma process and undergoes thermal contraction due to the elasticity thereof after the plasma process.

The repeated thermal expansion and contraction of the ground connector usually weakens the initial joint force of the bolt and thus the ground connector is gradually spaced apart from the elastic holder due to the weakened joint force therebetween. Therefore, a fine groove is generated between the ground connector and the elastic holder in proportional to the operational time of the PECVD apparatus.

Once the fine groove is generate between the ground connector and the elastic holder, an electric arc may be generated at the groove by a high voltage power for maintaining the plasma in the process chamber. The electric arc at the fine groove may critical damage to the ground connector and ceramics of the heater, thereby generating cracks on the heater. Thus, the instant spark between the ground connector and the elastic holder usually shortens the life span of the heater.

### DISCLOSURE OF THE INVENTION

### Technical Problem

Example embodiments provide a ground structure including a holder for holding a ground connector using elasticity thereof without a screw joint, thereby preventing separation of the holder and the ground connector by thermal expansion.

Other example embodiments provide a heater for a CVD including the above ground structure.

Still other example embodiments provide an apparatus for performing a CVD process including the above heater.

### Technical Solution

According to some example embodiments, there is provided a ground structure including a ground mount having a receiving a portion for receiving a ground connector through which a ground current flows outward to an external electrical reservoir, a ground clamp holding the ground connector in the receiving portion of the ground mount, a pair of stumbling portions folded from an outer surface of the ground clamp neighboring the opening portion and spaced apart from each other by a width of the opening portion and a ground wiring electrically connected to the ground clamp and the ground mount. The ground mount may be connected to an external electrical reservoir. The ground clamp may be shaped into a cylinder of which a sidewall is partially removed in a longitudinal direction to thereby include an opening portion through which an inner space of the cylinder may be communicated with an exterior of the ground clamp, and may enclose the ground connector such that an outer surface of the ground connector makes contact with an inner surface of the ground clamp. The ground current on the ground connector may flow to the ground mount via the ground clamp by the ground wiring, so that the ground current flows from the ground connector to the external electrical reservoir.

In some example embodiments, the ground connector may make surface contact with the ground clamp by an interference fit, so that the ground connector may be hold to the ground clamp by a frictional force on a contact surface between the ground connector and the ground clamp. For example, the ground connector may include a conductive metal and the ground clamp includes an elastic material.

In some example embodiments, the stumbling portion may include a protrusion protruded from an outer surface of the ground clamp neighboring the opening portion and an extension folded from the protrusion and extending in a circumferential line of the ground clamp, so that a gap space may be defined by the outer surface of the ground clamp and the stumbling portion.

In some example embodiments, the ground structure may further include a constrictor coupled to the stumbling portion. The constrictor may apply an attractive force to the symmetrical stumbling portions toward each other to thereby reinforce a frictional force between the ground connector and the ground clamp. For example, the constrictor may include an elastic metal clip.

In some example embodiments, a thermal expansion coefficient of the ground clamp may be about 50% to about 150% of that of the ground connector.

In some example embodiments, the ground structure may further include a conductive thin film coated on the inner surface of the ground clamp, so that the outer surface of the ground connector may make surface contact with the conductive thin film. For example, the conductive thin film includes any one material selected from the group consisting of gold (Au), silver (Ag), platinum (Pt) and compounds thereof.

In some example embodiments, the ground structure may further include a contact terminal positioned on an outer surface of the ground clamp and connected to the ground wring. For example, the contact terminal may include a contact hole penetrating the a sidewall of the ground clamp, a connecting unit inserted into the contact hole and a fixing unit fixing the connecting unit to the ground clamp. The fixing unit may include a nut and the connecting unit includes a bolt corresponding to the nut at an end portion thereof.

In some example embodiments, the ground connector may include nickel (Ni) and the ground clamp may include any one material selected from the group consisting of nickel (Ni), beryllium (Be), copper (Cu) and an alloy thereof.

In some example embodiments, the ground wiring may include a flexible cable such that the flexible cable absorbs the thermal expansion of the ground connector hold to the ground clamp. The receiving portion of the ground mount may include a ground hole at a bottom thereof, and thus the ground connector may be extended into the ground hole by thermal expansion in a longitudinal direction.

According to some example embodiments, there is provided a heater for a CVD apparatus having the ground structure. The heater may include a body having a flat upper surface on which a substrate is positioned, a ground electrode positioned in the body, a heating unit positioned in the body and generating heat for heating the substrate and a ground structure having the ground connector, the ground clamp and ground wiring. For example, the ground structure may include a ground mount having a receiving a portion for receiving a ground connector through which a ground current flows outward to an external electrical reservoir, a ground clamp holding the ground connector in the receiving portion of the ground mount, a pair of stumbling portions folded from an outer surface of the ground clamp neighboring the opening portion and spaced apart from each other by a width of the opening portion and a ground wiring electrically connected to the ground clamp and the ground mount. The ground current may flow from the ground electrode to the ground connector. The ground clamp may be shaped into a cylinder of which a sidewall is partially removed in a longitudinal direction to thereby include an opening portion through which an inner space of the cylinder may be communicated with an exterior of the ground clamp, and may enclose the ground connector such that an outer surface of the ground connector may make contact with an inner surface of the ground clamp. The ground current on the ground connector may flow to the ground mount via the ground clamp by the ground wiring, so that the ground current may flow from the ground connector to the external electrical reservoir.

In an example embodiment, the body may include one of ceramics and quartz. The ground structure may further include a through hole spaced from the receiving portion and penetrating through the ground mount. A power line for applying an electrical power to the heating unit may be connected to the heating unit and an external power source through the through hole.

According to some example embodiments, there is provided an apparatus for performing a CVD process having the above heater. The apparatus may include a process chamber in which the CVD process is performed on a substrate, a shower head positioned at an upper portion of the process chamber and injecting source gases for the CVD process to an inside of the process chamber, a plasma electrode to which an electric power is applied for transforming the source gases into plasma source, a heater positioned at a lower portion of the process chamber under the shower head and having a heating unit for heating the substrate and a ground electrode for discharging charged particles of the plasma source out of the process chamber as a ground current and a ground structure positioned under the heater. For example, the ground structure may include a ground mount having a receiving a portion for receiving a ground connector through which a ground current flows outward to an external electrical reservoir, a ground clamp holding the ground connector in the receiving portion of the ground mount, a pair of stumbling portions folded from an outer surface of the ground clamp neighboring the opening portion and spaced apart from each other by a width of the opening portion and a ground wiring electrically connected to the ground clamp and the ground mount. The ground current may flow from the ground electrode to the ground connector. The ground clamp may be shaped into a cylinder of which a sidewall is partially removed in a longitudinal direction to thereby include an opening portion through which an inner space of the cylinder may be communicated with an exterior of the ground clamp, and may enclose the ground connector such that an outer surface of the ground connector may make contact with an inner surface of the ground clamp. The ground current on the ground connector may flow to the ground mount via the ground clamp by the ground wiring, so that the ground current may flow from the ground connector to the external electrical reservoir.

In some example embodiments, the ground structure may further include a through hole spaced from the receiving portion and penetrating through the ground mount. A power line for applying an electrical power to the heating unit may be connected to the heating unit and an external power source through the through hole.

### Advantageous Effects

According to some example embodiments of the present inventive step, the ground connector extending from the ground electrode and the ground clamp enclosing the ground connector may be assembled by the interference fit in place of the conventional screw joint and the surface contact between the ground connector and the ground clamp may be reinforced by the constrictor. Thus, the ground connector and the ground clamp may be prevented from being separated from each other and the electric arc between the ground connector and the ground clamp may be sufficiently prevented, thereby minimizing damage to the ground connector which may be caused by the electric arc. Thus, the heater having the assembly of the ground connector and the ground clamp and the CVD apparatus including the heater may be prevented from being damaged by the electric arc, thereby reducing the maintenance cost of the CVD apparatus.

### BRIEF DESCRIPTION OF THE DRAWINGS

Example embodiments will be more clearly understood from the following detailed description taken in conjunction with the accompanying drawings.

FIG. 1 is a perspective view illustrating a ground structure for a CVD apparatus in accordance with an example embodiment of the present inventive concept.

FIG. 2 is a perspective view illustrating an assembly of a ground connector and a ground clamp shown in FIG. 1.

FIG. 3 is an explosive perspective view illustrating the ground connector and the ground clamp shown in FIG. 2.

FIG. 4 is a view illustrating a heater for a CVD apparatus with which the ground structure shown in FIG. 1 is provided in accordance with an example embodiment of the present inventive concept.

FIG. 5 is a view illustrating a chemical vapor deposition (CVD) apparatus including the heater shown in FIG. 4 in accordance with an example embodiment of the present inventive concept.

### BEST MODE FOR CARRYING OUT THE INVENTION

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings. A deposition apparatus for forming a thin layer on a semiconductor substrate such as a wafer may be provided as an example of an apparatus for processing a substrate hereinafter. However, the deposition apparatus is merely illustrative example embodiment and is not to be construed as limiting thereof. Thus, the lift pin of the present example embodiment of the present inventive concept may also be applied to various apparatus for processing the substrate such as a dry etching apparatus, a planarization apparatus and an ion implantation process just under condition that the process is performed onto the substrate positioned on a susceptor in the apparatus.

Ground Structure for a CVD Apparatus

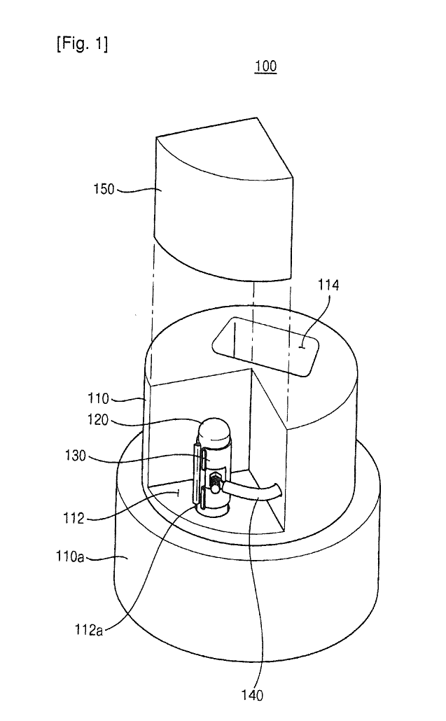

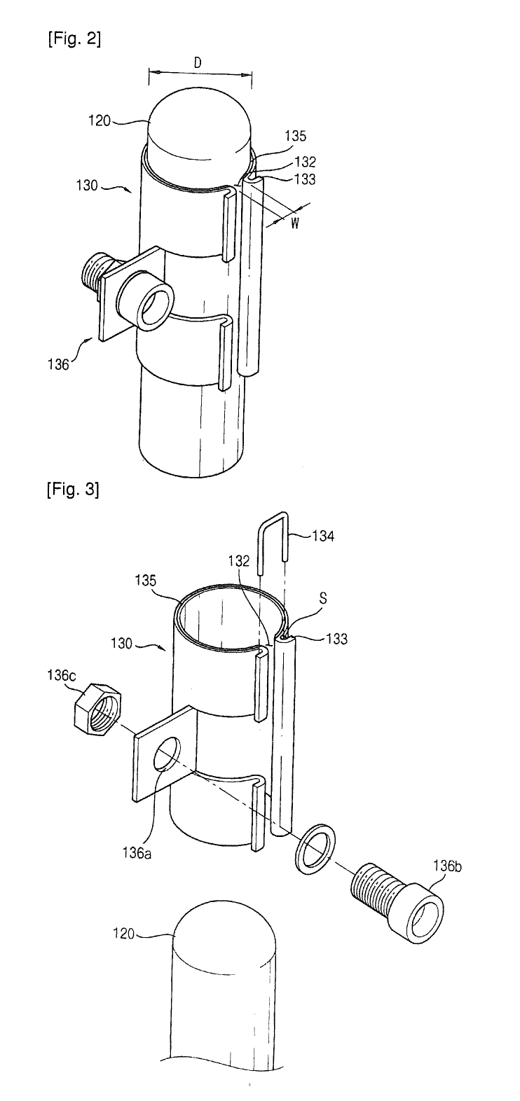

FIG. 1 is a perspective view illustrating a ground structure for a CVD apparatus in accordance with an example embodiment of the present inventive concept. FIG. 2 is a perspective view illustrating an assembly of a ground connector and a ground clamp shown in FIG. 1 and FIG. 3 is an explosive perspective view illustrating the ground connector and the ground clamp shown in FIG. 2.

Referring to FIGS. 1, 2 and 3, the ground structure 100 in accordance with an example embodiment of the present inventive concept may include a ground mount 110, a ground connector 120, a ground clamp 130, a stumbling portion 133, a constrictor 134 and a ground wiring 140.

In an example embodiment, the ground mount 110 may include a conductive body through which the ground connector 120 may penetrate and may have various shapes in accordance with the CVD apparatus and how to assemble with the CVD. In the present example embodiment, the ground mount 110 may be shaped into a cylinder and may be positioned at a bottom portion of the CVD apparatus or be inserted into an inside of a heat block. A support 110a may be provided to support the ground mount 110.

The ground mount 110 may include a receiving portion 112 having a ground hole 112a into which the ground connector 120 may be inserted, and thus the ground connector 120 may be received in the receiving portion 112 of the ground mount 110. Particularly, the ground clamp 130 making surface contact with the ground connector 120 and the ground wiring 140 electrically connected to the ground clamp 130 may be arranged in the receiving portion 112 of the ground mount 110. Ground currents on the ground connector 120 may pass toward the ground mount 110 via the ground wiring 140. In the present example embodiment, the ground mount 110 may include conductive metal materials having good electrical conductivity such as aluminum (Al), gold (Au) and silver (Ag).

In the present example embodiment, a fan-shaped portion may be cut off from the conductive body of the ground mount 110 and thus a fan-shaped space may be provided at the body of the ground mount 110 as the receiving portion 112. Thus, the receiving portion 112 may include a space sufficient for receiving the ground clamp 130 and the ground connector 120. For example, the fan-shaped receiving portion of the ground mount 110 may include a central angle of about 90°.

The ground connector 120 may penetrate through the ground hole 112a positioned at a bottom of the receiving portion 112 of the ground mount 110 and may make contact with a ground electrode of a heater that will be described hereinafter. Particularly, the receiving portion 112 of the ground mount 110 may have a sufficient size corresponding to a length of the ground connector 120, and thus the thermal expansion of the ground connector 120 along a longitudinal direction thereof may be sufficiently allowable in the receiving portion 112 without any limitations. Therefore, the thermal stress of the ground connector 120 caused by the limitation of the longitudinal thermal expansion may be sufficiently reduced, thereby preventing the cracks between the ground connector 120 and the ground electrode of the heater.

After completing the assembling of the ground connector 120 with the ground clamp 130, the receiving portion 112 of the ground mount 110 may be covered with a shielding cover 150 and thus the receiving portion 112 may be isolated from surroundings. Thus, the assembly of the ground connector 120 and the ground clamp 130 may be positioned in the fan-shaped space of the receiving portion 112 of the ground mount 11 with being isolated from the surroundings.

In addition, a through-hole 114 may be further provided with the ground mount 110. The through-hole 114 may be spaced apart from the receiving portion 112 and may penetrate through the conductive body of the ground mount 110. A power line (not shown) may be connected to a heat generator (not shown) of a CVD apparatus via the through-hole 114. For example, the power line may pass through the through-hole 114 of the ground mount 110. In such a case, the power line may be electrically insulated from the ground mount 110 by insulation materials interposed between the power line and the ground mount 110 in the through-hole 114.

In an example embodiment, the ground connector 120 may include a conductive metal rod and may be inserted into the ground hole 112a of the receiving portion 112. For example, the conducive metal rod may comprise a conductive metal having good electrical conductivity such as nickel (Ni) and copper (Cu) and ma be connected to the ground electrode of a heater block in the CVD apparatus. The ground connector 120 may function as a path of the ground current in the CVD apparatus.

In an example embodiment, the ground clamp 130 may be shaped into a cylinder of which the sidewall is partially removed in a longitudinal direction. Thus, the ground clamp 130 may include an opening portion 132 through which an inner space of the cylinder may be communicated with surroundings.

The ground connector 120 shaped into a rod may be inserted into the inner space of the cylindrical ground clamp 10, and thus an outer surface of the rod-shaped ground connector 120 may make surface contact with an inner surface of the cylindrical ground clamp 130. In such a case, a diameter of the ground clamp 130 may be determined within an allowable tolerance for an interference fit between the ground clamp 130 and the ground connector 120. That is, the ground clamp 130 and the ground connector 120 may be assembled to make surface contact with each other by the interference fit and thus the ground connector 120 may be firmly hold by the ground clamp 130 in the receiving portion 112 of the ground mount 110.

Particularly, the cylindrical ground clamp 130 may experience a heat treatment (e.g., an annealing process) under a temperature of about 300° C. to about 500° C., and thus residual stresses may be sufficiently removed from the ground clamp 130 and the ground clamp 130 may have sufficient initial elasticity. In the present example embodiment, the diameter of the ground clamp 130 may be about 50% to about 100% of that of the rod-shaped connector 120.

In addition, the surface contact between the ground clamp 130 and the ground connector 120 may also be maintained by the difference of each thermal expansion coefficient of the ground clamp 130 and the ground connector 120. For example, the coefficient of the thermal expansion of the ground clamp 130 may be about 50% to about 150% of that of the ground connector 120. When the coefficient of the thermal expansion of the ground clamp 130 is lower than that of the ground connector 120, the interference fitting of the ground clamp 130 and the ground connector 120 may be strengthened.

In contrast, when the coefficient of the thermal expansion of the ground connector 120 is lower than that of the ground clamp 130, the interference fitting of the ground clamp 130 and the ground connector 120 is likely to be loosened and thus the surface contact between the ground clamp 130 and the ground connector 120 is likely to be broken. In such a case, the constrictor 134 may be additionally provided with the ground clamp 130 and thus the surface contact between the ground clamp 130 and the ground connector 120 may be stably maintained.

For example, the ground clamp 130 may comprise the same materials as or similar materials to those of the ground connector 120 such as nickel (Ni) and nickel alloys. An example of the nickel alloys may include an alloy of nickel (Ni), beryllium (Be) and copper (Cu).

The opening portion 132 may extend in the longitudinal direction of the ground clamp 130 and the ground connector 120 having a length larger than that of the ground clamp 130 may be inserted into the inner space of the ground clamp 130 through the opening portion 132. Particularly, the ground connector 120 may be positioned closely to the opening portion 132 of the ground clamp 130 and an external force may be applied to the ground connector 120 toward the opening portion 132. Thus, the ground connector 120 may be put into the inner space of the ground clamp 130 via the opening portion 132. For example, the opening portion 132 may be formed by partially removing a circumferential surface of the ground clamp 130 corresponding to about 40% to about 100% of the diameter of the rod-shaped connector 120 and thus the opening portion 132 may have an initial width w corresponding to about 40% to about 100% of the diameter of the rod-shaped connector 120.

Due to the external force applied to the ground connector 120, the initial width w of the opening portion 132 may be enlarged to a degree substantially identical to the diameter of the ground connector 120 within an elastic limit of the ground clamp 130. Once the ground connector 120 is put into the inner space of the ground clamp 130 through the enlarged opening portion 132, enlarged width of the opening portion 132 may be reduced to the initial width w due to an elastic force of restitution. Accordingly, the rod-shaped connector 120 may be hold to the ground clamp 130 by a frictional force caused by the interference fit between the ground clamp 130 and the ground connector 120 and the restitution force of the ground clamp 130. That is, the ground connector 120 may be much more firmly hold to the ground clamp both by the frictional force and by the restitution force.

In an example embodiment, the stumbling portion 133 may be positioned on an outer surface of the ground clamp 130 around the opening portion 132. For example, the stumbling portion 133 may include a protrusion protruded from the outer surface of the ground clamp 130 around the opening portion 132 and an extension folded from the protrusion in a circumferential line of the outer surface of the ground clamp 130. Thus, the extension of the stumbling portion 133 may extend in parallel with the outer surface of the ground clamp 130 and be spaced apart from the outer surface of the ground clamp 130. The protrusion of the stumbling portion 133 may be shaped into a curve having a curvature larger than that of the ground clamp 130. In the present example embodiment, a pair of the stumbling portions 133 may be positioned around the opening portion 132 symmetrical to each other with respect to the opening portion 132.

Accordingly, a gap space S may be defined by the outer surface of the ground clamp 130 and the protrusion and the extension of the stumbling portion 133. A pair of the gap spaces S may also be arranged around the opening portion 132 of the ground clamp 130 symmetrically to each other with respect to the opening portion 132. While the present example embodiment discloses that the extension of the stumbling portion 133 may be curve along the circumferential line of the outer surface of the ground clamp 130, the extension may also be linear in parallel with a tangential line of the outer surface of the ground clamp 130. In addition, while the present example embodiment discloses that the stumbling portion 133 may be formed in a body together with the ground clamp 130, any other modifications known to one the ordinary skill in the art may be allowable to the stumbling portion 133. For example, the stumbling portion 133 may be detachably fixed to the ground clamp 130.

In an example embodiment, the constrictor 134 may be inserted into a pair of the gap spaces S around the opening portion 13 and thus may be coupled to the stumbling portion 133 of the ground clamp 130 after the ground connector 120 may be inserted into the inner space of the ground clamp 130, thereby reinforcing the surface contact between the ground connector 120 and the ground clamp 130. Once the constrictor 134 may be coupled to the stumbling portion 133, an attractive force may be applied to both of the symmetrical stumbling portions 133, and thus the pair of the stumbling portions 133 may be pulled toward each other in such a manner that the initial width w of the opening portion 132 may be reduced. For example, the constrictor 134 may comprise an elastic metal material, thus restitution force caused by the elasticity of the constrictor 134 may be applied to the constrictor 134 as the external force.

As a result, the frictional force may be reinforced between the outer surface of the ground connector 120 and the inner surface of the ground clamp 130, thereby stably maintaining the surface contact between the ground connector 120 and the ground clamp 130. For example, the constrictor 134 may include an elastic metal clip having an opened end portion and high elasticity such as a U-shaped lock clip. Further, the U-shaped lock clip may be modified to a closed clip by intercrossing the opened end portion of U-shaped lock clip like a capital letter ‘X,’ thereby improving locking quality and preventing loosening of the U-shaped lock clip in spite of a long-time usage thereof.

In addition, a conductive thin film 135 may be further formed on the inner surface of the ground clamp 130, thereby improving the electrical conductivity between the ground connector 120 and the ground clamp 130. For example, the conductive thin film 135 may be coated on a whole inner surface of the ground clamp 130, thereby minimizing the electrical resistance of the ground circuit including the ground connector 120 and the ground clamp 130. The conductive thin film 135 may comprise a low electrical resistive material such as gold (Au), silver (Ag) and platinum (Pt).

Therefore, the constrictor 134 may reinforce the contact force between the ground connector 120 and the ground clamp 130 and the conductive thin film 135 may reduce the electrical resistance between the ground connector 120 and the ground clamp 130. In case that the ground connector 120 may be thermally expanded due to a high temperature of a CVD process, the ground clamp 130 may also be thermally expanded in a radial direction to a degree substantially identical to or less than the thermal expansion of the ground connector 120. Therefore, the ground connector 120 and the ground clamp 130 may be sufficiently prevented from being separated from each other in spite of the high temperature in the CVD process. Further, the conventional screw joint of the ground connector and the ground clamp may be replaced by the interference fit between the ground connector 120 and the ground clamp 130, thereby preventing the deterioration of the surface contact between the ground connector 120 and the ground clamp 130 in spite of the repetition of the CVD process under high temperature.

A contact terminal 136 may be further provided with an outer surface of the ground clamp 130 and the ground wiring 140 may be connected to the contact terminal 136. The contact terminal 136 may have various structures and configurations as long as the ground clamp 130 and the ground wiring 140 may be sufficiently connected to each other via the contact terminal 136 under a high temperature for a CVD process. For example, the contact terminal 136 may include a terminal protrusion that may be protruded from the outer surface of the ground clamp 130 integrally together with the ground clamp 130. In such a case, the ground wiring 140 may penetrate through the terminal protrusion and thus the ground wiring 140 may be sufficiently prevented from being damaged by the high temperature and thermal expansion in both longitudinal and radial directions. The terminal protrusion and the ground wiring 140 may sufficiently make contact with each other by a screw structure.

In the present example embodiment, the contact terminal 136 may include a contact hole 136a penetrating a sidewall of the ground clamp 130, a connecting unit 136b inserted into the contact hole 136a and a fixing unit 136c fixing the connecting unit 136b to the ground clamp 130. For example, the fixing unit 136c may include a bolt and a nut corresponding to the bolt may be formed at an end portion of the connecting unit 136b, and thus the contact terminal 136 may include a bolt-nut assembly. While the present example embodiment discloses the bolt-nut assembly as the contact terminal 136, various connection assemblies may be used as the contact terminal 136 as long as the ground clamp 130 and the ground wiring 140 may be electrically connected to each other in the contact terminal 136, as would be known to one of the ordinary skill in the art.

A first end portion of the ground wiring 140 may be connected to the contact terminal 136 and a second end portion of the ground wiring 140 may be connected to the body of the ground mount 110. Thus, the electrical current transferring to the ground connector 120 may be grounded through the ground mount 110. Particularly, the ground wiring 140 may include a flexible cable and thus may be extended vertically in the receiving portion 112 of the ground mount 100. Therefore, the ground wiring 140 may sufficiently absorb the thermal expansion of the assembly of the ground clamp 130 and the ground connector 120 along the vertical direction in the receiving portion 112 of the ground mount 110.

According to the ground structure of the present example embodiment, the ground connector extending from the ground electrode and the ground clamp enclosing the ground connector may be assembled by the interference fit in place of the conventional screw joint and the surface contact between the ground connector and the ground clamp may be reinforced by the constrictor 134. Thus, the ground connector and the ground clamp may be prevented from being separated from each other and the electric arc between the ground connector and the ground clamp may be sufficiently prevented, thereby minimizing damage to the ground connector which may be caused by the electric arc.

Heater Having the Ground Structure

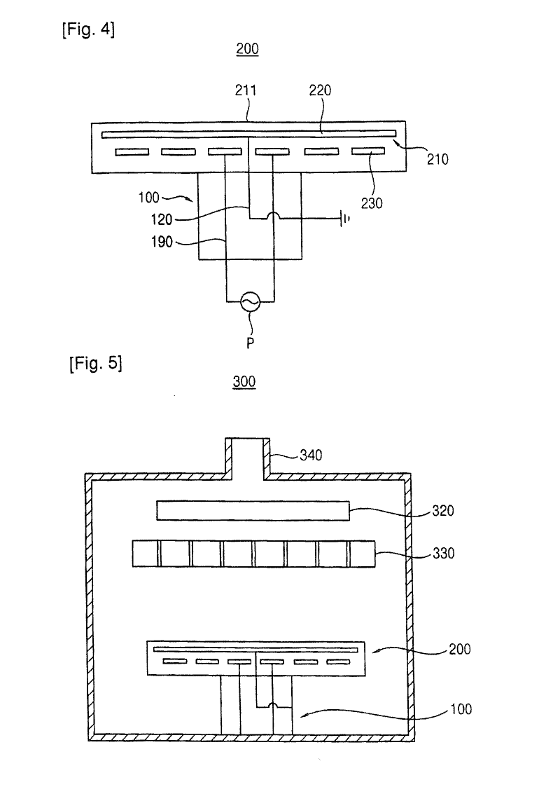

FIG. 4 is a view illustrating a heater for a CVD apparatus with which the ground structure shown in FIG. 1 is provided in accordance with an example embodiment of the present invention. In the present example embodiment, a heater for a plasma enhanced CVD (PECVD) apparatus is exemplarily disclosed, however, the heater is also applicable to other CVD apparatuses as long as the CVD apparatus needs the ground circuit that is connected to the ground electrode.

Referring to FIG. 4, the heater 200 for a CVD apparatus may include a heater body 210 having a flat upper surface 211, a ground electrode 220 positioned in the heater body 210 and transforming a portion of the plasma power to ground currents and a heating unit 230 positioned in the heater body 210 and generating heat. A substrate (not shown) to which a CVD process may be performed may be positioned on the flat upper surface of the heater body 210. The ground structure 100 shown in FIGS. 1, 2 and 3 may be positioned at a lower surface of the heater body 210 opposite to the upper surface 211.

The heater body 210 may comprise an electrical insulator and thus the ground electrode 220 in the heater body 210 may be electrically insulated from the ground mount 110 which may be positioned at a lower portion of the heater body 210. For example, the heater body 210 may comprise an insulation material having good etch-resistance against the source gases for the CVD process and good electrical insulation property such as ceramics and quartz. Otherwise, the heater body 210 may include a metal body having good thermal conductivity such as stainless steel (SUS) and an insulation film coated on a surface of the metal body. The insulation film may comprise ceramics or quartz.

The ground electrode 220 may be positioned in the heater body 210 and may generate the ground current from some of the particles of the plasma source in a PECVD process. As a result of the generation of the ground current, the plasma may have substantially constant intensity. An external power may be applied to the heating unit 230 to thereby generate heat and heating the substrate on the upper surface of the heater body 210. For example, the heating unit 230 may include an electric heater for generating joule heat in proportional to electrical current applied to the electric heater.

The ground electrode 220 may be electrically connected to the ground connector 120 of the ground structure 100 and the heating unit 230 may be electrically connected to the power line 190 through the through-hole 114 of the ground structure 100. Thus, the heating unit 230 may generate the joule heat in accordance with the electrical current applied from the external power source P. The ground connector 120 and the power line 190 may be enclosed by insulation media and thus may be electrically insulated from the metal-based ground mount 110.

The ground connector 120 and the power line 190 may be installed in the ground structure 100 in the same structure as described above in detail with reference to FIGS. 1, 2A and 2B. Thus, the electrical power may be applied to the heating unit through the power line 190 and the ground current caused by the particles of the plasma source in the process chamber may pass toward the ground mount 110 through the ground connector 120. The ground mount 110 may be connected to a support (not shown) for supporting the heater 200 and thus the ground current may be finally grounded to an external current reservoir such as an earth. The ground structure 100 may have the same structures and configurations as described above in detail with reference to FIGS. 1, 2 and 3, and thus any further detailed descriptions on the ground structure will be omitted.

According to the heater for a CVD, the ground electrode of the heater may be electrically connected to the external current reservoir through the ground connector of the ground structure and the heating unit of the heater may be electrically connected to the external power source through the power line through the through hole of the ground structure. The assembly of the ground connector and the ground clamp may be electrically connected to the ground mount by the flexible ground wiring, and thus the thermal expansion of the ground connector may be sufficiently absorbed by the extension of the flexible ground wiring. Therefore, the ground connector of the ground structure and the ground electrode of the heater may be sufficiently prevented from being separated from each other although the ground connector may be extended by the thermal expansion in a longitudinal direction. In addition, the ground connector and the ground clamp may also be prevented from separating from each other and thus the no gap may be generated between the ground connector and the ground clamp. Thus, the electric arc may be sufficiently prevented between the ground connector and the ground clamp and the damage to the ground connector caused by the electric arc may be prevented, thereby increasing the life span of the heater and decreasing the maintenance cost of the heater.

CVD Apparatus Including the Heater

FIG. 5 is a view illustrating a chemical vapor deposition (CVD) apparatus including the heater shown in FIG. 4 in accordance with an example embodiment of the present inventive concept. In the present example embodiment, a plasma-enhanced CVD (PECVD) apparatus is exemplarily disclosed as the CVD apparatus, however, the present inventive concept is also applicable to other CVD apparatuses as long as the CVD apparatus needs an electrical circuit for grounding an internal electrical current of the process chamber out of the process chamber.

Referring to FIG. 5, the CVD apparatus 300 in accordance with an example embodiment of the present inventive concept may include a process chamber 310 having an inner space closed from surroundings and in which a CVD process may be performed onto a substrate, a shower head 320 positioned at an upper portion of the process chamber and through which source gases for the CVD process may be injected, a plasma electrode 330 to which an electrical power for transforming the source gases into plasma may be applied, a heater 200 positioned at a lower portion of the process chamber 310 correspondently to the shower head 320 and heating the substrate, and the ground structure 100 having the power line 190 and the ground connector 120. Charged particles in the plasma source may be discharged from the process chamber 310 as a ground current through the ground electrode of the heater 200. An electric power may be applied to the heater 200 through the power line 190 of the ground structure 100 and the ground current may be guided from the ground electrode of the heater 200 to the external current reservoir through the ground connector 120 of the ground structure 100.

Although not shown in figures, the CVD apparatus 300 may further include a supply line for supplying the source gases to the shower head 320 and a discharge line connected to a bottom portion of the process chamber and discharging products and non-reacted source gases from the process chamber 310. A vacuum pump may be further installed to the discharge line.

The process chamber 310 may be closed and isolated from the surroundings and thus have a vacuum degree sufficient for the PECVD process and a substrate transfer and a load lock chamber may be further connected to the process chamber 310.

The shower head 320 may inject the source gases, which may be supplied through the supply line, into the process chamber 310 at a specific pressure. For example, the shower head 320 may have a size larger than or similar to the substrate and thus the source gases may be injected onto a whole surface of the substrate by the shower head 320.

A high frequency voltage power may be applied to the plasma electrode 330 and thus the source gases may be transformed into plasma in the process chamber 310. The plasma source may be accelerated onto the surface of the substrate that may be positioned on the heater 200 under the shower head 320.

The heater 200 may support the substrate and may be connected to the external power source through the power line of the ground structure 100 that may be positioned at a bottom portion of the heater 200. Thus, the substrate may be heated by the heater to which the electric power may be applied. The plasma source may be chemically reacted on the surface of the heated substrate and thus the source materials may be deposited onto the substrate, thereby forming a thin layer on the substrate. In such a case, the deposition temperature of the substrate may be varied in accordance with the thin layer on the substrate. For example, when a TEOS layer may be formed on the substrate, the substrate may need to be heated to the deposition temperature of about 360° C. to about 460° C. In the deposition process, the charged particles of the plasma source around the surface of the substrate may be condensed to the ground electrode of the heater 200 to thereby generate an electrical current called as the ground current. The ground current may be grounded to the external ground current reservoir through the ground connector of the ground structure 100. The ground connector and the power line may be arranged in the ground structure 100 that may be positioned at the bottom portion of the heater 200. The heater 200 and the ground structure 100 may be the same structures and configurations as described above in detail with reference to FIGS. 1 to 3, and thus any detailed descriptions on the ground structure and the heater will be omitted.

According to the CVD apparatus of the present example embodiment, charged particles of the plasma source may be discharged as the ground current from the process chamber through the rod-shaped ground electrode of the heater and the outer surface of the rod-shaped ground connector may make firm surface contact with the cylindrical-shaped ground clamp. Thus, the ground connector may be sufficiently held to the ground clamp in spite of the thermal expansion caused by the high temperature in the PECVD process. Therefore, although the ground current may excessively flow from the ground electrode of the heater, the electric arc may be sufficiently prevented between the ground connector and the ground clamp. Accordingly, no damage may be caused to the ground connector of the ground structure by the electric arc, thereby reducing the maintenance cost of the PECVD apparatus.

### INDUSTRIAL APPLICABILITY

According to the example embodiments of the present inventive concept, the ground connector extending from the ground electrode and the ground clamp enclosing the ground connector may be assembled by the interference fit in place of the conventional screw joint and the surface contact between the ground connector and the ground clamp may be reinforced by the constrictor 134. Thus, the ground connector and the ground clamp may be prevented from being separated from each other and the electric arc between the ground connector and the ground clamp may be sufficiently prevented, thereby minimizing damage to the ground connector which may be caused by the electric arc. Thus, the heater having the assembly of the ground connector and the ground clamp and the CVD apparatus including the heater may be prevented from being damaged by the electric arc, thereby reducing the maintenance cost of the CVD apparatus.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

1. A ground structure comprising:
a ground mount having a receiving a portion for receiving a ground connector through which a ground current flows outward to an external electrical reservoir; a ground clamp holding the ground connector in the receiving portion of the ground mount, the ground clamp being shaped into a cylinder of which a sidewall is partially removed in a longitudinal direction to thereby include an opening portion through which an inner space of the cylinder is communicated with an exterior of the ground clamp, and enclosing the ground connector such that an outer surface of the ground connector makes contact with an inner surface of the ground clamp;
a pair of stumbling portions folded from an outer surface of the ground clamp neighboring the opening portion and spaced apart from each other by a width of the opening portion; and
a ground wiring electrically connected to the ground clamp and the ground mount, the ground current on the ground connector flowing to the ground mount via the ground clamp by the ground wiring, so that the ground current flows from the ground connector to the external electrical reservoir.

2. The ground structure of claim 1, when the ground connector makes surface contact with the ground clamp by an interference fit, so that the ground connector is hold to the ground clamp by a frictional force on a contact surface between the ground connector and the ground clamp.

3. The ground structure of claim 2, wherein the ground connector includes a conductive metal and the ground clamp includes an elastic material.

4. The ground structure of claim 1, wherein the stumbling portion includes a protrusion protruded from an outer surface of the ground clamp neighboring the opening portion and an extension folded from the protrusion and extending in a circumferential line of the ground clamp, so that a gap space is defined by the outer surface of the ground clamp and the stumbling portion.

5. The ground structure of claim 4, further comprising a constrictor coupled to the stumbling portion, the constrictor applying an attractive force to the symmetrical stumbling portions toward each other to thereby reinforce a frictional force between the ground connector and the ground clamp.

6. The ground structure of claim 5, wherein the constrictor includes an elastic metal clip.

7. The ground structure of claim 1, wherein a thermal expansion coefficient of the ground clamp is about 50% to about 150% of that of the ground connector.

8. The ground structure of claim 1, further comprising a conductive thin film coated on the inner surface of the ground clamp, so that the outer surface of the ground connector makes surface contact with the conductive thin film.

9. The ground structure of claim 8, wherein the conductive thin film includes any one material selected from the group consisting of gold (Au), silver (Ag), platinum (Pt) and compounds thereof.

10. The ground structure of claim 1, further comprising a contact terminal positioned on an outer surface of the ground clamp and connected to the ground wring.

11. The ground structure of claim 10, wherein the contact terminal includes a contact hole penetrating the a sidewall of the ground clamp, a connecting unit inserted into the contact hole and a fixing unit fixing the connecting unit to the ground clamp.

12. The ground structure of claim 11, wherein the fixing unit includes a nut and the connecting unit includes a bolt corresponding to the nut at an end portion thereof.

13. The ground structure of claim 1, wherein the ground connector includes nickel (Ni) and the ground clamp includes any one material selected from the group consisting of nickel (Ni), beryllium (Be), copper (Cu) and an alloy thereof.

14. The ground structure of claim 1, wherein the ground wiring includes a flexible cable such that the flexible cable absorbs the thermal expansion of the ground connector hold to the ground clamp.

15. The ground structure of claim 14, wherein the receiving portion of the ground mount includes a ground hole at a bottom thereof, the ground connector being extended into the ground hole by thermal expansion in a longitudinal direction.

16. A heater for a chemical vapor deposition apparatus, comprising:
a body having a flat upper surface on which a substrate is positioned;
a ground electrode positioned in the body;
a heating unit positioned in the body and generating heat for heating the substrate; and
a ground structure including a ground mount having a receiving a portion for receiving a ground connector through which a ground current flows outward to an external electrical reservoir, a ground current flowing from the ground electrode to the ground connector; a ground clamp holding the ground connector in the receiving portion of the ground mount, the ground clamp being shaped into a cylinder of which a sidewall is partially removed in a longitudinal direction to thereby include an opening portion through which an inner space of the cylinder is communicated with an exterior of the ground clamp, and enclosing the ground connector such that an outer surface of the ground connector makes contact with an inner surface of the ground clamp; a pair of stumbling portions folded from an outer surface of the ground clamp neighboring the opening portion and spaced apart from each other by a width of the opening portion; and a ground wiring electrically connected to the ground clamp and the ground mount, the ground current on the ground connector flowing to the ground mount via the ground clamp by the ground wiring, so that the ground current flows from the ground connector to the external electrical reservoir.

17. The heater of claim 16, wherein the body includes one of ceramics and quartz.

18. The heater of claim 16, wherein the ground structure further includes a through hole spaced from the receiving portion and penetrating through the ground mount, a power line for applying an electrical power to the heating unit being connected to the heating unit and an external power source through the through hole.

19. An apparatus for performing a chemical vapor deposition (CVD) process, comprising:
a process chamber in which the CVD process is performed on a substrate;
a shower head positioned at an upper portion of the process chamber and injecting source gases for the CVD process to an inside of the process chamber;
a plasma electrode to which an electric power is applied for transforming the source gases into plasma source;
a heater positioned at a lower portion of the process chamber under the shower head and having a heating unit for heating the substrate and a ground electrode for discharging charged particles of the plasma source out of the process chamber as a ground current; and
a ground structure positioned under the heater,
wherein the ground structure includes a ground mount having a receiving a portion for receiving a ground connector through which a ground current flows outward to an external electrical reservoir, a ground current flowing from the ground electrode to the ground connector; a ground clamp holding the ground connector in the receiving portion of the ground mount, the ground clamp being shaped into a cylinder of which a sidewall is partially removed in a longitudinal direction to thereby include an opening portion through which an inner space of the cylinder is communicated with an exterior of the ground clamp, and enclosing the ground connector such that an outer surface of the ground connector makes contact with an inner surface of the ground clamp; a pair of stumbling portions folded from an outer surface of the ground clamp neighboring the opening portion and spaced apart from each other by a width of the opening portion; and a ground wiring electrically connected to the ground clamp and the ground mount, the ground current on the ground connector flowing to the ground mount via the ground clamp by the ground wiring, so that the ground current flows from the ground connector to the external electrical reservoir.

20. The apparatus of claim 19, wherein the ground structure further includes a through hole spaced from the receiving portion and penetrating through the ground mount, a power line for applying an electrical power to the heating unit being connected to the heating unit and an external power source through the through hole.
